(19) United States
(12) Patent Application Publication
(10) Pub. No.: US 2022/0055334 A1
(43) Pub. Date: Feb. 24, 2022

(54) Media Creaser

(71) Applicant: Hewlett-Packard Development Company, L.P., Spring, TX (US)

(72) Inventors: Joseba Ormaechea Saracibar, Sant Cugat del Valles (ES); Ferran Alex Paris Casadella, Sant Cugat del Valles (ES); Felix Ruiz Martinez, Sant Cugat del Valles (ES); Elena Rodriguez Fernandez, Sant Cugat del Valles (ES)

(73) Assignee: Hewlett-Packard Development Company, L.P., Spring, TX (US)

(21) Appl. No.: 17/417,251

(22) PCT Filed: Apr. 29, 2019
(86) PCT No.: PCT/US2019/029665

§ 371 Date: Jun. 22, 2021

(51) Int. Cl. B31F 1/10; B41F 13/56

(52) U.S. Cl. CPC B31F 1/10; B65H 2404/513; B65H 2301/5126; B41F 13/56

(57) ABSTRACT

A printer is described, including a media input, a media output and a print zone located between the media input and the media output; a media transport path extending from the media input to the media output and across the print zone; and a media creasing assembly located at the media transport path.

### BACKGROUND

Printed products may be subject to post-processing, such as creasing and folding. For this, a creasing device may be provided in addition to a printer.

### BRIEF DESCRIPTION OF DRAWINGS

The following description references the drawings, wherein

FIG. 1 shows a schematic perspective view of part of a printer including a creasing assembly, according to an example;

FIG. 2 shows a schematic perspective view of part of printer including the creasing assembly, according to the example, with further details;

FIG. 3 shows a schematic perspective view of part of printer including the creasing assembly, according to the example, with further details;

FIG. 4 shows a schematic front view of part of printer including a creasing assembly, according to another example;

FIG. 5 shows a schematic perspective view of part of a printer including a creasing assembly according to another example;

FIG. 6 shows a schematic perspective view of a creasing assembly including a creasing module attached to a carriage according to another example;

FIG. 7 shows a schematic perspective view of the creasing module of FIG. 6, without the carriage;

FIG. 8 shows a schematic perspective view of part of creasing module according to another example;

FIG. 9 shows a flow diagram of a method according to an example; and

FIG. 10 shows a flow diagram of a method according to another example.

### DESCRIPTION OF EXAMPLES

A printer, for example a large format printer, may have a media creasing assembly or creasing device integrated therein. For example, the printer may include a media input, a media output and a print zone located between the media input and the media output. A media transport path extends from the media input to the media output and across the print zone. A media creasing assembly may be located in or at the media transport path, i.e. between the media input and the media output and in the interior of the printer. The media creasing assembly may be located upstream or downstream of the print zone, or it may be located at least partially in the print zone or overlap the print zone or part of the media creasing assembly may be located upstream and another part may be located downstream of the print zone.

By integrating the creasing assembly in the printer, manual transfer and alignment of a printed product to a separate creaser is avoided and the overall footprint of a system for printing and post-processing may be reduced. Further, the creasing assembly can be implemented by adding relatively simple creasing modules to the printer wherein the creasing assembly may share the media transport mechanisms and drives of the printer for the creasing operation.

If a creasing module is located between the media input and the print zone, i.e. upstream of the print zone, applying creasing pressure to a print media during or after printing is avoided. The creasing modules will not come into contact with the printed product, avoiding that a printed image is smeared or otherwise compromised. Depending on the printer architecture, a creasing module also may be located between the print zone and the media output, i.e. downstream of the print zone, e.g. if this complies with a more efficient printer configuration.

The media creasing assembly may include at least one of an X direction creasing module and a Y direction creasing module, wherein the Y direction is a media advance direction along a media transport path and the X direction is perpendicular to the Y direction. In one example, the media creasing assembly includes one X direction creasing module and a number y of Y direction creasing modules wherein the number y may correspond to the number of creasing lines to be produced in the Y direction; in various examples y=1, 2, 3, 4, 5, 6, 7, or 8.

The printer may be a large-format printer and may include a printer carriage to carry a print head across a print zone. The printer carriage, for example, may be an inkjet printer carriage and may carry an array of print heads containing printing fluids e.g. four, CMYK, ink inkjet print heads. The printing fluid may be dispensed from the print heads. The carriage scans across a print medium in the print zone while the print heads are selectively fired to generate a printed plot.

In one example, the media creasing assembly may include an X direction creasing module coupled to the printer carriage to follow movement of the carriage across the print zone. In another example, the media creasing assembly may include an X direction creasing module supported by a creaser carriage which is slidably engaged with a shaft that may be separate from the printer carriage shaft to cause movement of the X direction creasing module along the shaft and across the print zone. In still another example, the media creasing assembly may include an X direction creasing module extending across the width of the print zone in a direction perpendicular to the Y direction.

The media creasing assembly may further include a Y direction creasing module coupled to the printer carriage to be positioned by the printer carriage at a Y direction creasing position. In another example, the media creasing assembly may include a Y direction creasing module slidably arranged on a shaft, the shaft extending across the print zone in a direction perpendicular to the Y direction. The Y direction creasing module can be positioned along the shaft, relative to the print zone, at a location where a creasing line in the Y direction is to be generated. To simultaneously generate multiple creasing lines in the Y direction, multiple Y direction creasing modules can be provided and e.g. may be slidably arranged on the shaft.

The X and/or Y direction creasing modules, in the following sometimes referred to as modules, may be configured to be raised and lowered to be brought into and out of contact with a print medium advancing through the printer. For example, the X and/or Y direction creasing modules may be configured to rotate or pivot around the shaft for upwards and downwards movement. In another example, the X and/or Y direction creasing modules may be configured to linearly move upwards or downwards, as explained in further detail below.

In one example, the X and/or Y direction creasing modules include a movable creasing tool to engage a surface of the print medium. The movable creasing tool may include a rotary creasing wheel. The X and/or Y direction creasing modules further may include or be associated to a counter surface to engage the print medium between the movable creasing tool and the counter surface, wherein the counter surface may include a notch. Accordingly, in one example, the print medium may be creased by engaging the print medium between the rotary creasing wheel and the notch, with the rotary creasing wheel rolling along the notch and clamping the print medium between the rotary creasing wheel and the notch to create the crease line.

In an example, the creasing tool lacks sharp edges, at least, in the section of the tool that is to engage the media thereby avoiding cutting the media while performing the creasing action. Furthermore, the creasing tool may be provided as to be perpendicular to the media, thereby lacking a cutting-edge inclination between the creasing tool and the media. Also the counter surface may be configured to be raised and lowered to be brought into and out of contact with a surface of the print medium advancing through the printer. In another example, the counter surface may be stationary below a print medium creasing area or may be provided by, in or on a print platen. In one example, the X and/or Y direction modules may be arranged above the print medium and the counter surface may be arranged below the print medium, in the vertical or Z direction.

The X and/or Y direction creasing modules may be located at, adjacent to or close to the print zone, such as at a distance to the print zone which is between 0 and 20 cm. This enables a compact printer format and the generation of creasing lines well aligned with a printed image.

Alternatively or additionally to a creasing wheel, other types of creasing tools may be included in the media creasing assembly, such as at least one of a laser, a media corrosive print fluid, a needle, a stake and a blade. For example, a media corrosive print fluid may be provided through a printhead carried by a carriage of the printer. Also a laser could be attached to the printer carriage, for example. Other creasing tools, such as a needle, a stake and a blade could be provided in X and/or Y direction creasing modules, similar to the ones described herein.

In the example of a creasing module slidably arranged on a shaft, the creasing module may comprise a movable creasing tool and a transmission group transmitting rotation of the shaft to movement of the creasing tool. Movement of the creasing tool may relate to both rotation of a creasing wheel, for example, and upwards and downwards movement of the creasing tool for engagement and disengagement with the print medium.

In using the creasing assembly, a print medium may be advanced towards a print zone of a printer, with a leading edge of the print medium crossing the print zone in a media advance direction; the print medium may be engaged by a creasing module; and printing on the print medium in the print zone and generating a creasing line on the print medium in the media advance direction may be performed simultaneously. Further, for generating a creasing line on the print medium in a direction traversing the media advance direction, printing may be interrupted and may be continued after the creasing line has been created.

The printer may be a large format printer which prints on a continuous web of a print medium, such as a continuous web of paper, carton, textile or foil, for example. The print medium also may be provided as single sheets that are fed from an input tray or a drawer, or a roll of paper, for example. The printer may be an inkjet printer or another type of scanning printer which comprises a printer carriage which carries one or several print heads. The printer carriage may scan across a print zone in a scanning direction and the print head(s) may deposit a printing fluid on the print medium, when the print medium is transported through the print zone in a print media advance direction. For example, one replaceable ink jet print head or four, CMYK, ink inkjet print heads may be provided in the carriage. A printing fluid may be dispensed from the print heads which may be any fluid that can be dispensed by an inkjet-type printer or other inkjet-type dispenser and may include inks, varnishes, and/or post or pre-treatment agents, for example.

A print zone may be defined as the entire area or part of the area which can be traversed by the carriage and thus the print heads. The scanning direction of the carriage also may be designated as X direction, the print media advance direction also may be designated as Y direction, and the direction of gravity is designated as Z direction. In the context of this application, a front view of the printer and creasing assembly corresponds to a view in the X-Z plane, and a side view corresponds to a view in the Y-Z plane. A top view corresponds to a view in the X-Y plane.

FIGS. 1 to 3 schematically show part of a printer with increasing detail, the printer including a creasing assembly according to an example. FIGS. 1 to 3 schematically show a printer carriage 10 which can move along a slide bar or shaft 12 in the scanning direction or X direction, illustrated by arrow X. In the example, the carriage 10 carries print heads 16 for dispensing printing fluids, e.g. printheads for dispensing CMYK inks and a post-treatment fluid. An X direction creasing module 20 and an Y direction creasing module 50 are attached to the printer carriage 10 and will be described in further detail below. The printer carriage 10 and the creasing modules 20, 50 are located above a print zone through which a print medium is to be transported from a printer input to a printer output and where a print fluid is to be deposited on the print medium. The printer may further comprise a platen (not shown) to support the print medium in the print zone, and a print medium advance system to transport the print medium through the print zone in the media advance direction Y, from the printer input to the printer output. The print media advance system may comprise media transport rollers (schematically shown at 408, 410 in FIG. 1).

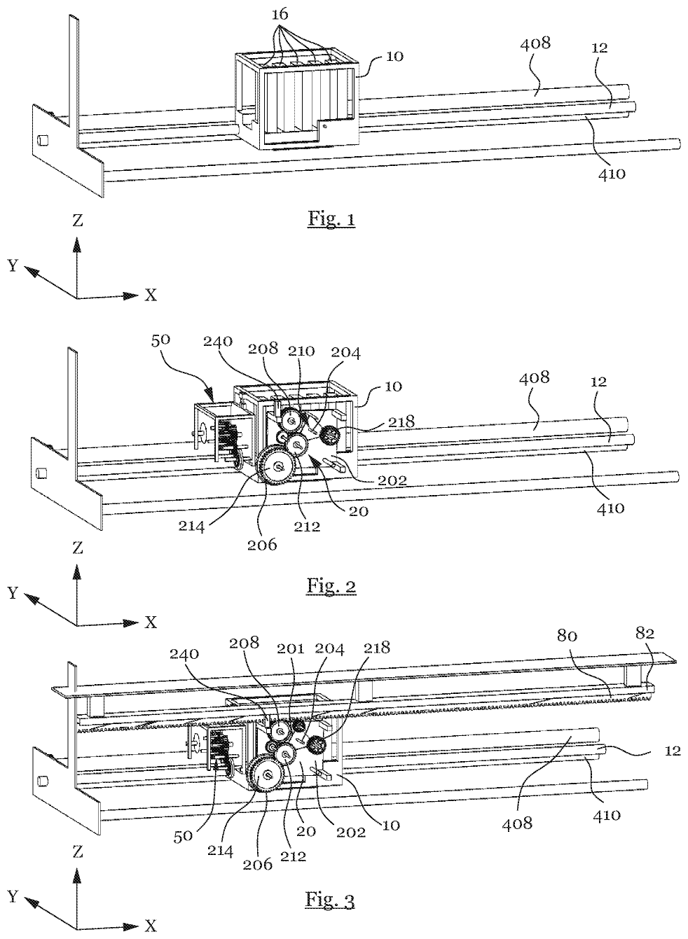

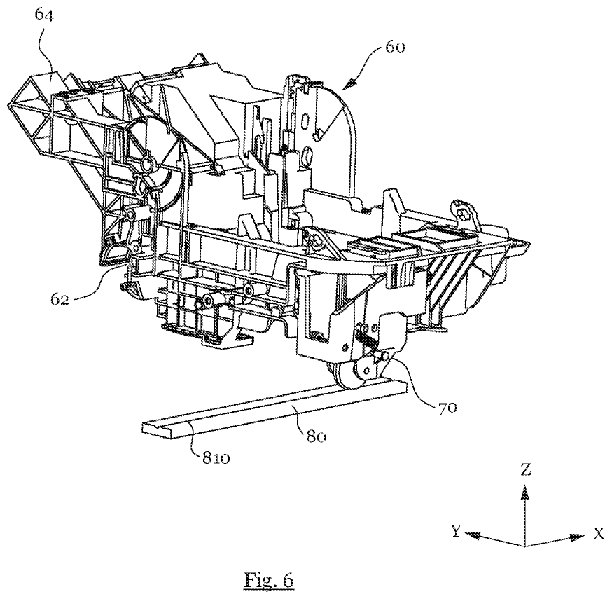

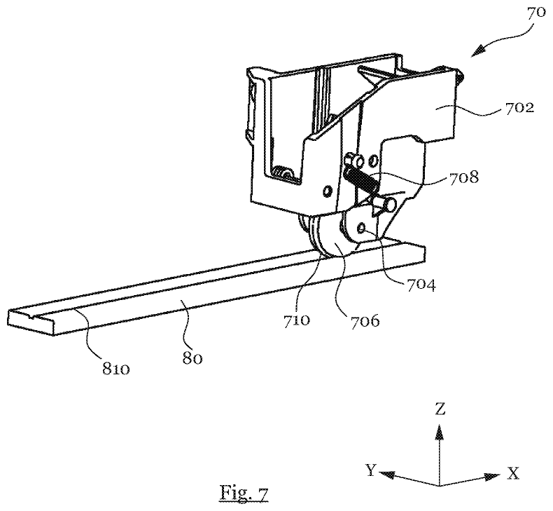

The X direction creasing module is shown in further detail in FIGS. 2 and 3 and is designed to create a creasing line in the scanning direction X. The Y direction creasing module is shown in further detail FIG. 5 and is designed to create a creasing line in the media advance direction Y.

FIG. 3 additionally shows a movable toothed rack 80 interacting with the X direction creasing module to drive a rotary creasing wheel, as described below.

In this example, the X direction creasing module 20 may comprise a pivotable support frame 202 having a pivot point 204 at which the X direction creasing module 20 is pivotably coupled to the printer carriage, a rotary creasing wheel 206, and a transmission 210 including a drive gear 208. The X direction creasing module 20 can be pivoted around the pivot point 204, from a standby position to a creasing position, using a pusher component 240.

In this example, the X direction creasing module 20 is located at a side of the carriage lo which extends parallel to the scanning direction X and also the rotary creasing wheel 206 extends in a plane parallel to the scanning direction X. The carriage side to which the X direction creasing module 20 is attached may be the front side or the backside of the carriage, in the media advance direction Y, depending on whether the creasing assembly should be located upstream or downstream of the print zone.

In this specific example, the transmission 210 comprises the drive gear 208 and an intermediate gear 212, between the drive gear 208 and a gear 214 coupled and coaxial to the rotary creasing wheel 206. Additional transmission elements to change a transmission ratio are schematically shown at 218. The gears may be toothed gears or friction gears or may be replaced or supplemented by other transmission elements. The gears may be plastic or metal parts. The drive gear 208, the intermediate gear 212 and the rotary creasing wheel 206, including its gear 214, are rotatably coupled to the support frame 202.

The drive gear 208 may be coupled with the linear toothed rack 80 to rotate along the rack 80 when the carriage moves in the X direction. This will drive the rotary creasing wheel 206 to rotate on the surface of the print medium and generate a creasing line therein. To this end, the rack may be the movable in the Z direction to engage and disengaged the rack 80 with/from the drive gear 208. Parallel to the rack 80, a sliding surface 82 may be provided to come into contact with the pusher component 240 when the rack is lowered to pivot the X direction creasing module 20 from a standby position to a creasing position.

Still with reference to FIG. 3, when the drive gear 208 is engaged with the linear rack 80 and when the carriage 10 and hence the X direction creasing module 20 move in the carriage scanning direction X, the drive gear 208 revolves on the linear rack 80 and rotation of the drive gear 208 is transmitted to the rotary creasing wheel 206 via the intermediate gear 212 to create a creasing line in the print medium between the rotary creasing wheel 206 and the counter surface 304.

Other types of creasing tools may be used instead of or in addition to the rotary creasing wheel 206, for example, a linear or static creasing tip or blade. Further, a non-driven rotary creasing wheel may be provided, which rotates on the surface of the print medium by pressing the creasing wheel against the print medium surface and moving the carriage 10 in the X direction.

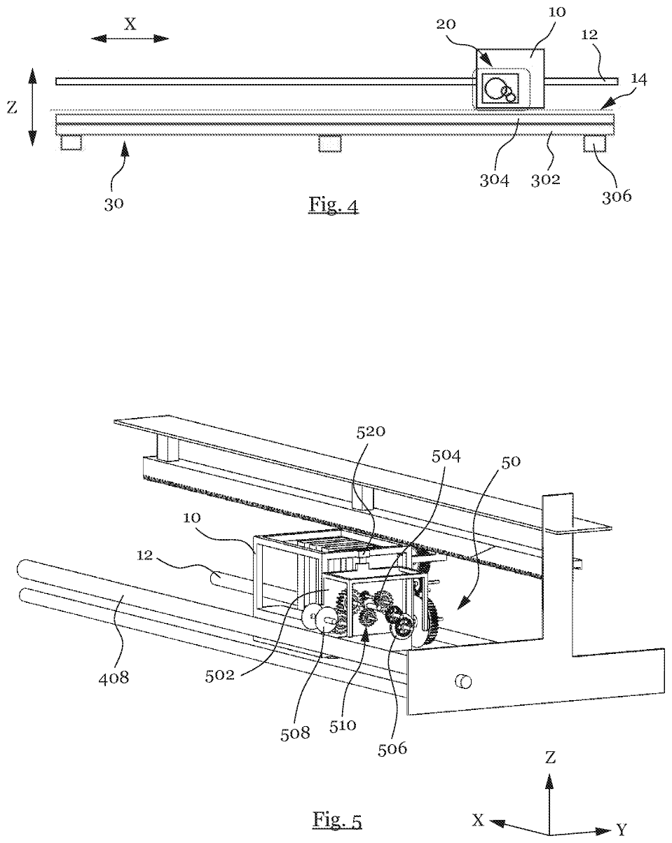

FIG. 4 schematically shows another example of a creasing module attached to a printer carriage 10 which can move along a slide bar or shaft 12 in the scanning direction or X direction, illustrated by arrow X. Attached to the printer carriage 10 is an X direction creasing module 20, which may be configured similar to the one described above with respect to FIGS. 1 to 3 or in a different way. The printer carriage 10 and the creasing modules 20 are located above a print zone through which a print medium is to be transported from a printer input to a printer output and where a print fluid is to be deposited on the print medium. The printer may further comprise a platen (not shown) to support the print medium in the print zone, and a print medium advance system to transport the print medium through the print zone in the media advance direction Y, from the printer input to the printer output.

As schematically shown in FIG. 4, a counter surface module 30 including a counter surface 304 may be provided below the print medium, which in FIG. 4 is schematically shown at 14. The counter surface 304 may extend parallel to the carriage scanning direction X. The counter surface module 30 can be raised and lowered in the Z direction to engage and disengage a lower surface of the print medium 14. The counter surface 304 may be provided with a notch to engage with the rotary creasing blade, as explained further below.

The counter surface module 30 may be coupled with an electromotive or electromagnetic actuator or several actuators 306 (see FIG. 4) to raise and lower the counter surface module 30 and hence to engage and disengage the rotary creasing wheel 206 and the counter surface 304. Raising of the counter surface module 30 also may cause the X direction creasing module 20 to pivot around pivot point 204 from a standby position to a creasing position. Alternatively, the X direction creasing module 20 may be transferred to the creasing position by another type of mechanism, such as an electromotive or electromagnetic actuator associated with the X direction creasing module 20.

The Y direction creasing module 50 may be configured in a way similar to the X direction creasing module 20. The details of an example of a Y direction creasing module 50 are illustrated in FIG. 5.

In the example illustrated in FIG. 5, the Y direction creasing module 50 is shown in a perspective view, in a direction opposite to FIGS. 1 to 3. The Y direction creasing module 50 may be arranged at a side face of the carriage 10 so that a rotary creasing wheel 506 extends in the media advance direction Y. Similar to the previous examples, the Y direction creasing module 50 may comprise a pivotable support frame 502 having a pivot point 504 at which the creasing module 50 is pivotably coupled to the printer carriage 10, a Y direction creasing wheel 506, and a transmission 510 including a drive gear 508 and intermediate gears. The carriage side to which the Y direction creasing module 50 is attached may be the left-hand side or the right-hand side of the carriage, depending on whether the creasing assembly should be located upstream or downstream of the carriage movement from left to right or from right to left.

In this specific example, the transmission 510 may comprise a gear train having a variable transmission ratio but also could be implemented with fewer gears and a fixed transmission ratio, for example. The gears may be toothed gears or friction gears or may be replaced or supplemented by other transmission elements. In another example, the Y direction creasing wheel may be non-driven and rotates when in contact with the surface of the print medium moving relative to the creasing wheel.

Drive gear 508 may be engaged with one of the transport rollers of a media advance system, such as a driven output roller 408. When the drive gear 508 is engaged with the output roller 408 and when the media advance system drives a print medium in the media advance direction Y or in the opposite direction, drive gear 508 revolves on output roller 408 and rotation of the drive gear 508 is transmitted to the Y direction creasing wheel 506 via the transmission 510 to generate a creasing line in the print medium between the Y direction creasing wheel 506 and a counter surface, not illustrated in FIG. 5. A counter surface extending in the media advance direction Y may be provided below the media transport plane, opposite to the Y direction creasing wheel 506.

The Y direction creasing module 50 of this example may be translated to its creasing position by an electromotive or electromagnetic or another type of actuator 520, for example. The actuator 520 may lower and raise and/or pivot the support frame 502 of the Y direction creasing module to lower and raise the creasing we 506 and to engage and disengage the drive gear 508 and the output roller 408 which, in this example, is a drive component of the Y direction creasing module.

In the various examples, the creasing assembly has a rotary creasing wheel, which is driven without a separate drive motor or another dedicated active actuator or impelling mechanism. In various examples, the rotary creasing wheel is driven by rotation of the shaft, carriage movement or by rotation of a media transport roller. The creasing assembly can be associated with a printer carriage to generate a creasing line in either the X direction or the Y direction of both. The creasing assembly comprises a drive component which, in one variant, includes a linear rack which can be engaged with the drive gear. In another variant, the drive component includes a drive roller which may be a media transport roller of a media transport system. The drive component can be raised or lowered and/or the creasing module can be raised or lowered or pivoted, to engage the drive gear with the drive rack or to engage the drive gear with the media transport roller so that, when creasing module is moved by movement of the carriage (for forming a creasing line in X direction) or when the drive gear is engaged with the media transport roller (for forming a creasing line in Y direction), the drive gear or roller rotates and transmits rotation to the rotary creasing wheel.

FIGS. 6 and 7 show schematic perspective views of a creasing assembly including an X direction creasing module 70 attached to a creaser carriage 60 according to another example, wherein FIG. 7 shows the X direction creasing module 70 of FIG. 6, without the carriage. The creasing assembly may be provided in a printer, such as a large format printer, e.g. an inkjet printer. For further details of the printer, reference is made to the above description.

FIGS. 6 and 7 schematically show the creaser carriage 60 which can be arranged to move along a slide bar or shaft (not shown) in the scanning direction or X direction, illustrated by arrow X. The shaft may be provided in addition and parallel to a shaft for carrying a printer carriage, such as shaft 12 of FIGS. 1 to 3. Attached to the creaser carriage 60 is the X direction creasing module 70, described in further detail below. The creaser carriage 60 and the creasing module 70 are located above a print zone through which a print medium is to be transported from a printer input to a printer output and where a print fluid is to be deposited on the print medium, or adjacent to a print zone, upstream or downstream thereof. The creasing module may travel across a print medium along an X direction creasing path which may overlap with the print zone or which may be downstream or upstream from the print zone, e.g. at a distance of up to 5 cm, 10 cm, or 20 cm, for example.

A creasing support rail 80 including a notch 810 may be located opposite to the X direction creasing module 70, so that the creasing module 70 and the creasing support rail 80 are located on two opposite sides of a print medium (not shown) when the print medium is advanced through the printer. The X direction creasing module 70 is designed to create a creasing line in the scanning direction X.

The creaser carriage 60 may include a hollow space 62 to be fitted on and engaged with the shaft. Engagement between the creaser carriage 60 and the shaft may be achieved by sliding the creaser carriage 60 over the shaft or by a snap fit or clamping engagement, for example. The carriage 60 also may be pivotable relative to the shaft, e.g. in a range of 45° to 180°, to raise and lower the X direction creasing module 70 between a raised standby position and a lowered creasing position. The creaser carriage 60 may, for example, have a handle like extension 64, for grabbing and pivoting the carriage 60 between the standby position and the creasing position wherein FIG. 6 shows the creasing assembly in the creasing position.

The printer may further comprise a platen (not shown) to support the print medium in the print zone, and a print medium advance system to transport the print medium through the print zone in the media advance direction Y, from the printer input to the printer output. The printer further may include a printhead carriage arranged on a shaft, which may extend parallel to the shaft (not shown) guiding the creasing carriage 60, downstream or upstream of the creasing assembly shown in FIGS. 6 and 7.

FIG. 7 shows further details of the X direction creasing module 70 according to an example. The X direction creasing module 70 comprises a body or frame 702 for attaching the module to the carriage 60 and for rotatably supporting a creasing wheel 706 on an axis 704. A bistable spring 708 may be provided to keep the creasing module in a working position or in a standby position. The X direction creasing module 70 can be attached to the carriage 60 by a snap fit engagement or by removable screws so that the X direction creasing module 70 is readily replaceable.

The creasing wheel 706 may have a substantially flat peripheral surface including a protruding circumferential ridge 710 at the center of the peripheral surface, for example. The ridge 710 may cooperate with a corresponding notch 810 formed in the creasing support rail 80.

To form a creasing line in a print medium, the creasing assembly of FIG. 6, including the carriage 60 and the X direction creasing module 70 may be pivoted from a standby position to a creasing position (shown in FIG. 6) and the creasing support rail 80 either may be stationary or may be raised from a standby position to a creasing position, with the print medium located between the support rail 80 and the X direction creasing module 70 at a position where a to be formed creasing line is aligned with the notch 80. The carriage 61 is moved along the shaft (not shown) in the X direction so that the creasing wheel 706 revolves on the print medium along the notch 810 of the creasing support 80. The creasing wheel 706 may be driven or not driven, i.e. may revolve on print medium surface by friction contact with the surface.

After the creasing line is completed, the creasing assembly may be pivoted back upwards to the standby position and the support rail 80 may remain stationary or may be lowered to a respective standby position. The print medium then can be further transported through the printer to continue printing or to output the print medium.

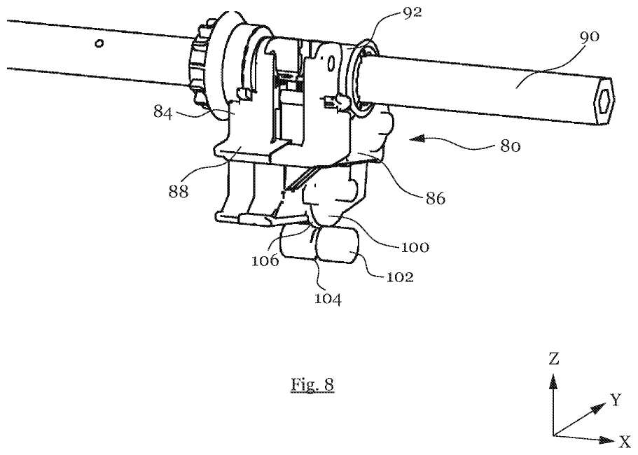

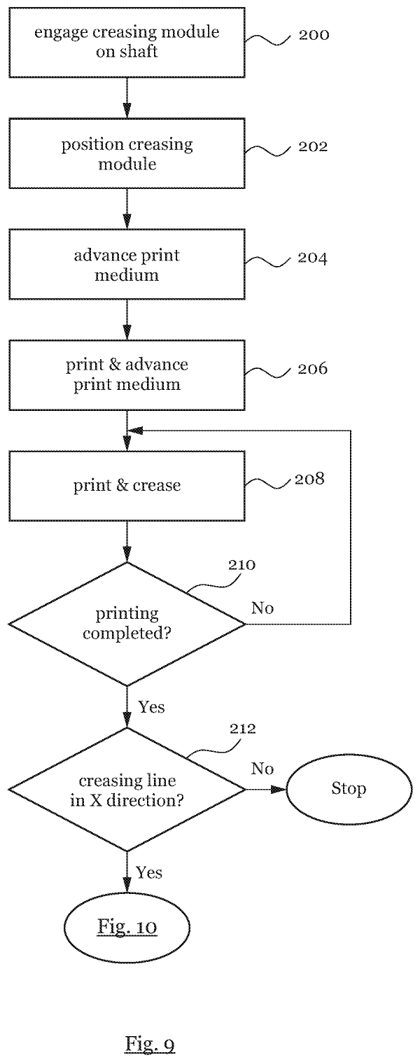

FIG. 8 shows a schematic perspective view of a creasing assembly including a Y direction creasing module 80 attached to a slide bar or shaft 90 via a transmission ring 92 according to another example. The creasing assembly may be provided in a printer, such as a large format printer, e.g. an inkjet printer.

In the illustrated example, the shaft 90 has a polygonal cross-section, such as a hexagonal cross-section wherein other cross-sections, including a circular or noncircular, elliptic or a non-symmetrically shaped cross-section may be provided. The Y direction creasing module 80 is coupled to the shaft 90 by the transmission ring 92. In the example, the transmission ring 92 is engaged with the outer periphery of the shaft 90 in a formfitting manner wherein, alternatively or additionally, a press fit or engagement by additional fixing elements, such as a screw, a bracket, adhesive or the like may be provided.

In the illustrated example, the Y direction creasing module 80 comprises an upper module half 84 and a lower module half 86 which clamp the transmission ring 92. In FIG. 8, a handle-like extension 88 is provided at the upper module half 84. This handle-like extension can be grabbed and pressed to pivot the upper and lower module halves 84, 86 relative to each other to engage and disengage the module halves 84, 86 from the transmission ring 92 and latch and unlatch the Y direction creasing module 80. Accordingly, the Y direction creasing module 80 can be replaced by unlatching the creasing module 80 from the transmission ring 92 and inserting another creasing module by the reverse operation.

In the example, the Y direction creasing module 80 comprises a creasing wheel 100 which may be configured as or similar to the creasing wheel 706 of the X direction creasing module 70 described above. The creasing wheel 100 may be driven to rotate by rotation of the shaft 90, via a transmission group (not shown) provided in the creasing module 80. The transmission group may have an adjustable transmission ratio. In another example, the creasing wheel 100 may be not actively driven and may rotate by friction contact with the print medium transported between the creasing wheel 100 and a counter surface or counter roller 102, such as the one shown in FIG. 8, for example. The counter roller 102 may include a notch 104 for engagement with a respective ridge 106 provided on the peripheral surface of the creasing wheel 100. Accordingly, the creasing wheel 100 may interact with the counter roller 102, to form a creasing line in the print medium which is transported in the Y direction between the creasing wheel 100 and the counter roller 102.

The transmission group (not shown) in the Y direction creasing module 80 may include a gear train designed to rotate in one direction and to block rotation in the other direction. In one example, if the shaft 90 rotates in the counterclockwise direction, rotation will be transmitted by the transmission group to the creasing wheel 100 so that the creasing wheel 100 will be driven to rotate in the clockwise direction to roll along the print medium and form a creasing line. If, however, the shaft 90 rotates in the clockwise direction, the gear train may lock and rotation of the shaft 90 may pivot the entire Y direction creasing 80 from a creasing position shown in FIG. 8 upwards to a standby position where the Y direction creasing module 80 is moved out of the plane of print media transport. The Y direction creasing module 80 may be pivoted around the shaft 90 e.g. in a range of 45° to 180° from the creasing position shown in the drawings to the standby position. To this end, one of multiple gears of the transmission group can be implemented as a locking gear interacting with a ratchet pawl which allows rotation in one direction but not in the other direction, for example.

A printer according to an example may comprise one, two, or more Y direction creasing modules 80, such as the one shown in FIG. 8. The number of Y direction creasing modules may depend on the number of creasing lines to be formed simultaneously in the Y direction. Each Y direction creasing module 80 may be positioned along the length of the shaft 90 at a desired creasing position by respectively positioning the transmission ring 92 and attaching the respective Y direction creasing module 80 to its associated transmission ring 92.

FIG. 9 shows a flow diagram of a media creasing process to form one or a plurality of creasing lines in the media advance direction Y, according to an example. The process may be performed in a printer, such as an inkjet printer, including a creasing assembly having two Y direction creasing modules 80, such as the one shown in FIG. 8. The process may comprise engaging the Y direction creasing modules 80 and the shaft 90, at block 200, and moving the Y direction creasing modules 80 along the shaft 90 to desired lateral positions across the width of the print zone, at block 202. The Y direction creasing modules are positioned where creasing lines are to be formed in the print medium. The print medium then is advanced towards the print zone of the printer, at block 204, with a leading edge of the print medium crossing the print zone in the media advance direction Y. The print medium (not shown in the drawings) can be a print medium, such as a single sheet or a continuous web of print medium fed to the print zone from an input tray, a drawer or roll of paper, for example. The medium may be paper or a foil, for example. The print medium can be fed by media feed rollers which are arranged downstream and/or upstream of the print zone, by a belt or a number of belts and/or by rollers integrated in the print platen, for example.

Once the print medium has arrived at the print zone, the printer can start printing swaths of a print fluid, such as ink, and advancing the medium through the print zone, at block 206. Once the leading edge of the print medium arrives at the Y direction creasing modules 80, the print medium can be engaged between the creasing wheel 100 and the counter roller 102, and the process can continue with printing on and creasing the print medium while advancing the printing medium, at block 208. If the circumferential speed of the creasing wheel 100 is higher than the media advance speed, rotation of the creasing wheel 100 can create a tensioning effect which pulls the print medium in the media advance direction so that the print medium is held flat and tensioned, improving the creasing performance. Concurrent with the creasing operation, printing on the print medium may be performed. The creasing wheel 100 may be aligned to a direction parallel substantially parallel to the media advance direction Y.

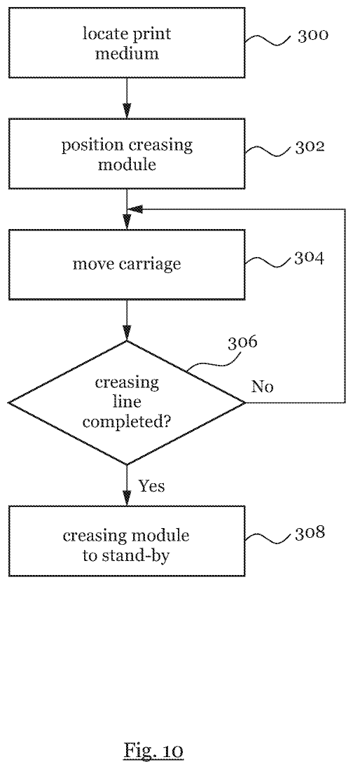

At block 210 it is checked whether printing of an entire image or a predetermined fraction of the image is completed. If yes, the print medium can be moved further in the media advance direction to check whether a creasing line in the X direction is to be formed, at block 212. If yes, the process can advance to forming a creasing line in the X direction, e.g. as illustrated with reference to FIG. 10.

If no, the process can loop back to printing increasing, at 208. The print medium continues to be advanced in the media advance direction Y, with continued printing and creasing operations, as long as the printing process is not completed and creasing lines shall be formed. Printing on the print medium in the print zone and forming the creasing lines and the print medium in the media advance direction can be performed simultaneously in what may be considered a single operation. It also can be performed intermittently.

If the process continues with forming a creasing line in the X direction, the print medium also can be moved in the reverse direction, i.e. in a direction opposite to the print media advance direction Y, by a defined distance, to position the print medium such that the X direction creasing line is properly located. When forming the creasing line in the X direction, the Y direction creasing modules 80 may be pivoted upwards to the standby position.

A similar process to the one shown in FIG. 9 may be performed using the Y direction creasing module 50 illustrated in FIG. 5. A creasing sequence for forming a creasing line in the media advance direction Y using the Y direction creasing module 50 of FIG. 5, according to an example, may comprise: positioning the printer carriage 10 at a point of a medium where a creasing line is to be formed, with the Y direction creasing module 50 lifted up and in the standby position. At this point, the Y direction creasing module 50 is lowered, e.g. by the actuator 520, so that the drive roller 508 contacts the transport roller 408 and the Y direction creasing module 50 is pivoted downwards to the creasing position. In the creasing position, the creasing wheel 506 may engage and overlap with a counter surface including a notch. When the transport roller 408 is rotated in the media advance direction Y or in the opposite direction, the print medium is transported below the Y direction creasing module 50 and, at the same time, rotation of the transport roller 408 is transferred to the creasing wheel 506, to form a creasing line in the print medium between the creasing wheel 506 and an opposite counter surface in the media advance direction Y, wherein the creasing wheel 506 is driven by the drive roller 508 revolving on the transport roller 408 (drive component) and the transmission 510. Once the creasing operation is completed, the transport roller 408 may be stopped and the Y direction creasing module 50 may be raised, e.g. by the actuator 520, so that the creasing wheel 506 disengages from the counter surface and the Y direction creasing module 50 is transferred back to the standby position. As the Y direction creasing module 50 is attached to the carriage 10, in this example, creasing and printing would not be performed simultaneously.

FIG. 10 shows a flow diagram of a media creasing process to form a creasing line in the media advance direction X, according to an example. The process may be performed in a printer, such as an inkjet printer, including a creasing assembly having an X direction creasing module 70, such as the one shown in FIGS. 6 and 7.

The process may comprise locating a print medium in the creasing zone, e.g. above creasing support 80 shown in FIGS. 6 and 7, where a creasing line is to be formed, at block 300. Then the creasing assembly, e.g. the one including the carriage 60 and the X direction creasing module 70 of FIGS. 6 and 7, is located at the side of the print zone and the carriage 60 and hence the X direction creasing module 70 is pivoted downwards to a creasing position, at block 302. While the print medium is at rest, the carriage 60 is moved along the shaft (not shown) in the X direction across the width of the print medium, with the print medium engaged between the creasing wheel 706 and the notch 810 in the counter surface of the creasing support 80, to form an X direction creasing line, at block 304. At 306, it is checked whether the creasing line is completed. If no, movement of the carriage and forming of the creasing line continues, at 304. If yes, the creasing assembly, including the carriage 60 and the X direction creasing module 70, may be pivoted upwards back to the standby position, at block 308. If further X direction creasing lines shall be formed, the print medium may be transported through the printer and relocated below the X direction creasing assembly, and the process may be repeated.

A similar process may be performed using the X direction creasing module 20, shown and described with respect to FIGS. 1 to 3. In this example, a creasing sequence for forming a creasing line in the scanning direction X according to an example may comprise: positioning the printer carriage 10 at a longitudinal side of a print medium or another point of the medium where a creasing line is to be formed, with the drive component including the linear rack 80 lifted up and the X direction creasing module 20 in the standby position; lowering the linear rack 80, e.g. by using a suitable actuator, so that the linear rack 80 is brought into contact with the drive gear 208 and the X direction creasing module 20 is pivoted from a standby position to a creasing position using the pusher component 240. To this end, the pusher component 240 may come into contact with the sliding surface 82 aligned with the linear rack 80. Accordingly, the support frame 202 is pivoted so that the X direction creasing module 20 is transferred to the creasing position. In the creasing position, the creasing wheel 206 may engage and overlap with the counter surface 304, as shown in FIG. 4. Then the carriage 10 is moved in the scanning direction X to form a creasing line in the print medium between the creasing wheel 206 and the linear counter surface 304 in the scanning direction X, wherein the creasing wheel 206 may be driven by the drive gear 208 revolving on the linear rack 80 and the transmission 210. When the creasing operation is completed, the carriage 10 is stopped and the drive component including the linear rack 80 may be raised, so that the pusher component 240 disengages from the sliding surface 82 and the support frame 202 is pivoted back, e.g. by a biasing force provided by a spring (not shown), so that the X direction creasing module 20 is transferred back to the standby position.

Drive of the print media advance system (not shown), the shaft 90 as well as other entities of the printer and associated creasing equipment may be controlled by a controller (not shown). The controller can be a microcontroller, ASIC, or other control device, including control devices operating based on hardware or a combination of hardware and software. It can include an integrated memory or communicate with an external memory or both. The same controller or separate controllers may be provided for controlling carriage movement, media advance and the rotary actuator. Different parts of the controller may be located internally or externally to a printer or creasing assembly, in a concentrated or distributed environment.

1. A printer including
a media input, a media output and a print zone located between the media input and the media output;
a media transport path extending from the media input to the media output and across the print zone; and
a media creasing assembly located at the media transport path.

2. The printer of claim 1 wherein the media creasing assembly includes at least one of an X direction creasing module and a Y direction creasing module, wherein the Y direction is a media advance direction along the media transport path and the X direction is perpendicular to the Y direction.

3. The printer of claim 2 further including a printer carriage to carry a print head across the print zone wherein the media creasing assembly includes an X direction creasing module coupled to the printer carriage to follow movement of the carriage across the print zone.

4. The printer of claim 2 further including a printer carriage to carry a print head across the print zone wherein the media creasing assembly includes an X direction creasing module slidably engaged with a shaft separate from the printer carriage to cause movement of the X direction creasing module along the shaft and across the print zone.

5. The printer of claim 2 wherein the media creasing assembly includes an X direction creasing module extending across the width of the print zone in a direction perpendicular to the Y direction.

6. The printer of claim 2 further including a printer carriage to carry a print head across the print zone wherein the media creasing assembly includes a Y direction creasing module coupled to the printer carriage to be positioned by the printer carriage at a Y direction creasing position.

7. The printer of claim 2 further including a Y direction creasing module slidably arranged on a shaft, the shaft extending across the print zone in a direction perpendicular to the Y direction.

8. The printer of claim 2 wherein at least one of the X and Y creasing modules includes a movable creasing tool to engage a surface of the print medium.

9. The printer of claim 8 wherein the movable creasing tool includes a rotary creasing wheel.

10. The printer of claim 8 wherein the at least one of the X and Y creasing modules includes a counter surface to engage the print medium between the movable creasing tool and the counter surface, wherein the counter surface includes a notch.

11. The printer of claim 2 wherein the at least one of the X and Y creasing modules is located in, upstream or downstream of the print zone, at a distance to the print zone which is between 0 and 20 cm.

12. The printer of claim 1 wherein the media creasing assembly includes at least one of a laser, a media corrosive print fluid, a needle, a stake and a blade.

13. A creasing assembly to be integrated in a printer, the creasing assembly including a creasing module slidably arranged on a shaft, the shaft extending in a direction perpendicular to a media advance direction of the printer;
wherein the creasing module comprises a movable creasing tool and a transmission group transmitting rotation of the shaft to movement of the creasing tool.

14. A method including
advancing a print medium towards a print zone of a printer, with a leading edge of the print medium crossing the print zone in a media advance direction;
engaging the print medium by a creasing module;
printing on the print medium in the print zone and simultaneously generating a creasing line on the print medium in the media advance direction.

15. The method of claim 14, further including
interrupting the printing;
generating a creasing line on the print medium in a direction traversing the media advance direction; and
continuing the printing.
